(19) United States
(12) Patent Application Publication
(10) Pub. No.: US 2019/0293349 A1
(43) Pub. Date: Sep. 26, 2019

(54) DRYING NOZZLE

(71) Applicant: BOBST BIELEFELD GMBH, Bielefeld (DE)

(72) Inventor: Thomas BOJE, Bielefeld (DE)

(21) Appl. No.: 16/302,987

(22) PCT Filed: May 24, 2017
(86) PCT No.: PCT/EP2017/025147

§ 371 Date: Nov. 19, 2018

(30) Foreign Application Priority Data
May 25, 2016 (DE) 20 2016 102 780.2

(51) Int. Cl. F26B 13/10; F26B 21/00; F26B 13/14

(52) U.S. Cl. CPC F26B 13/108; F26B 13/145; F26B 21/004

(57) ABSTRACT

The invention is about a drying system to be applied on the central drum of a flexographic machine. The dryer is made of two concentric cylinders: the outer one having a slot—or several slots with different thicknesses—the inner one having a slot with a trapezoid shape. By adjusting the relative position of the trapeze and the outer slot sets the effective size of the vent, which determines the air flow coming out of the dryer. This results in a simple and reliable way of configuring the drying of the print.

The invention relates to a drying nozzle for gassing a running printing substrate web in a rotary printing machine, comprising a hollow nozzle body that has a nozzle slot extending transversely to the direction of travel of the printing substrate web.

In rotary printing machines, drying nozzles are used to dry the printing ink of the images printed on the printing substrate web. For this purpose, a drying gas, for example air, is introduced into the hollow nozzle body, the nozzle slit of which is directed onto the printing substrate web so that the printing substrate web is gassed uniformly with the drying gas over the entire width and thereby dried.

The object of the invention is to provide a drying nozzle that can be easily adapted to different applications.

This object is achieved according to the invention in that the nozzle body has an inner pipe and an outer pipe surrounding the inner pipe, which in each case have at least one outlet opening in their circumferential wall, and that the nozzle slot is formed by an overlapping zone of the outlet openings of the inner pipe and of the outer pipe, by changing the angular position of the inner pipe relative to the outer pipe.

The invention thus allows the configuration of the nozzle slot to be adapted to the respective requirements by changing the relative angular position of the inner pipe and the outer pipe and thus changing the size of the overlapping zone.

In this way, for example, the length of the nozzle slot can be adapted in the direction transverse to the travel direction of the printing substrate web to different web widths or widths of the printed images. It is also possible to vary the width of the nozzle slot in order to optimize the throughput and the outflow speed of the drying gas.

Advantageous embodiments and further developments of the invention are given in the subordinate claims.

In an embodiment, the outlet opening of the outer pipe or of the inner pipe is slot-shaped, while the outlet opening of the other pipe extends over a greater circumferential angle and tapers in one direction in circumferential direction. Due to this taper, the length of the nozzle slot changes as a function of the angle of rotation of the two pipes.

In another embodiment, the inner pipe or the outer pipe can have a plurality of parallel slot-shaped outlet openings with different widths, while the other of these two pipes has a slot-shaped outlet opening, the width of which corresponds at least to the largest slot width of the outlet openings of the former pipe. The width of the nozzle slot can then be adjusted by bringing one of several different wide outlet slots of one pipe into alignment with the outlet slot of the other pipe.

The two embodiments mentioned above can be combined with one another.

In yet another embodiment, each of the two pipes has a slot-shaped outlet opening and the width of the nozzle slot is adjusted by twisting these two slot-shaped outlet openings more or less widely towards one another.

Embodiments of the invention are explained in more detail below with reference to the drawing.

Shown are:

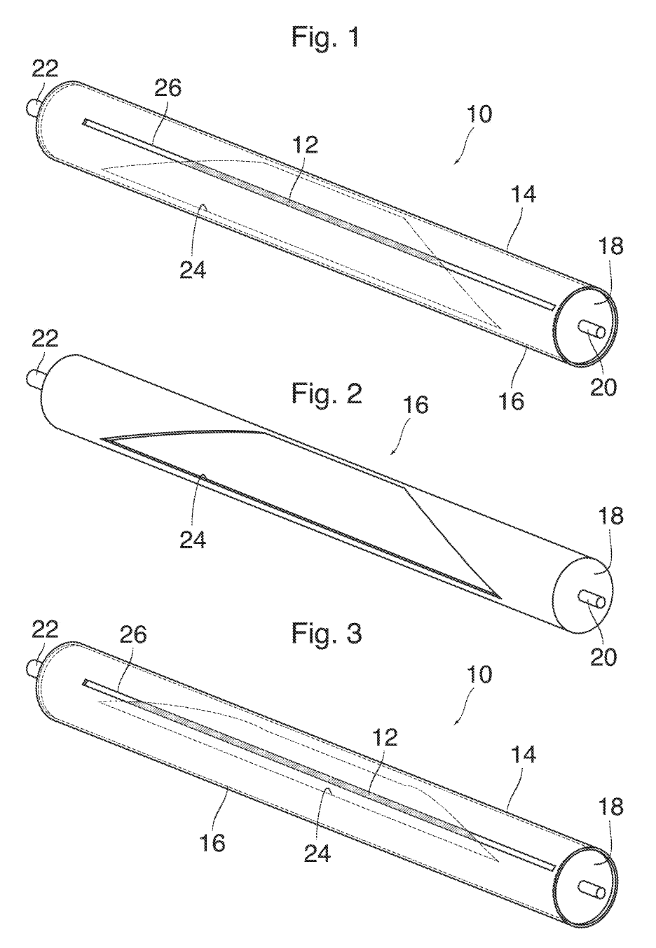

FIG. 1 a perspective view of a drying nozzle according to an embodiment of the invention;

FIG. 2 a perspective view of an inner pipe of the drying nozzle according to FIG. 1;

FIG. 3 a perspective view corresponding to FIG. 1, but for another setting position of the drying nozzle;

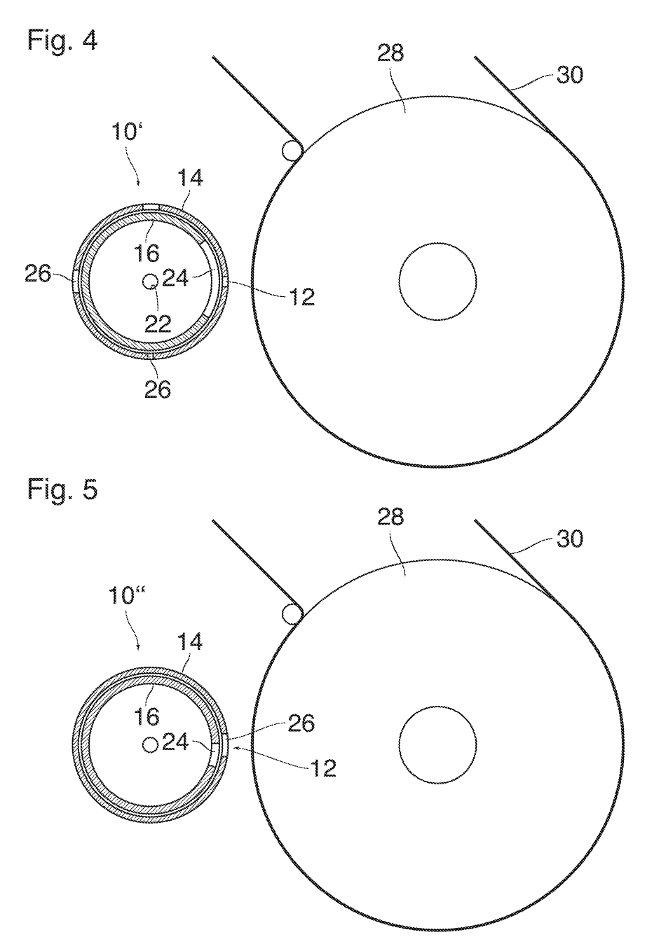

FIG. 4 a cross-section of a drying nozzle according to another exemplary embodiment, together with a printing substrate web guided over a cylinder of the printing machine; and

FIG. 5 a cross-section of a drying nozzle according to a further exemplary embodiment.

The drying nozzle shown in FIG. 1 has a cylindrical nozzle body 10, in the circumferential wall of which a nozzle slot 12 is formed, which extends in the axial direction of the nozzle body. The nozzle body 10 has a cylindrical outer pipe 14 and a likewise cylindrical inner pipe 16, which is tightly enclosed by the outer pipe 14.

In the example shown, the outer pipe 14 is open at both ends, while the inner pipe 16 is closed at the ends by end walls 18. One of the end walls 18 carries an axle stub 20 that protrudes from the open end of the outer pipe 14 and thus allows the inner pipe 16 to rotate inside the outer pipe 14. The other end wall of the inner pipe 16 in FIG. 1, facing away from the observer, has an inlet connection piece 22, through which a drying gas, for example, dried or temperature-controlled air can be introduced into the hollow interior of the inner pipe 16.

In the circumferential wall of the inner pipe 16, an outlet opening 24 is formed in trapezoidal shape in development, which at the base extends almost over the entire length of the inner pipe 16, but tapers in the circumferential direction A slot-shaped outlet opening 26 is formed in the circumferential wall of the outer pipe 14, the length of which approximately corresponds to the length of the trapezoidal outlet opening 24 at the base thereof and the width of which defines the width of the nozzle slot 12. This nozzle slot is formed by the overlapping zone between the outlet openings 24 and 26 and can thus be varied in its length (in the axial direction of nozzle body 10) by twisting the inner pipe 16 relative to the outer pipe 14. In this case, the axle stub 20 can serve as a rotary handle, to which also a motorized rotary drive can optionally engage, so that an automatic adjustment of the width of the nozzle slot 12 is made possible.

The outer circumferential surface of the inner pipe 16 can contact the inner circumferential surface of the outer pipe 14 over entire surface so that practically no drying air can escape through a gap formed between the inner and outer pipe. In another embodiment, the inner pipe and the outer pipe may also be separated by spacers (not shown) so that the friction resistance is reduced during rotation of the inner pipe. However, the width of the gap formed between the inner pipe and the outer pipe by the spacers should be dimensioned such that the leakage flow escaping through this gap is negligible.

In FIG. 2, the inner pipe 16 is shown separately, so that the outlet opening 24 can be seen more clearly. This outlet opening extends over a circumferential angle of the inner pipe 16 that is significantly greater than the circumferential angle over which the slot-shaped outlet opening 26 of the outer pipe extends. In the extreme case, the outlet opening 24 can extend over a circumferential angle of up to 360°.

FIG. 3 again shows the complete nozzle body 10, but in a state in which the inner pipe 16 is twisted with respect to the outer pipe 14 such that the overlapping zone between the outlet openings 24 and 26 that forms the nozzle slot 12 has a greater length. In this way, the length of the nozzle slot can be adapted to the respective width of a printing substrate web to be dried.

FIG. 4 shows a cross-sectional view of a nozzle body 10′ of a drying nozzle according to another exemplary embodiment. This drying nozzle is arranged with the help of a holder (not shown) on the circumference of a cylinder 28 of a printing machine, over which a printing substrate web 30 runs. The nozzle body 10′ extends parallel to the axis of the cylinder 28 at least over the entire width of the printing substrate web 30 and is oriented such that its outlet slot 12 is directed towards the printing substrate web.

In this example, the outlet opening 24 of the inner pipe 16 extends over a circumferential angle of almost 90° and it can have approximately the same shape as in FIGS. 1 to 3. On the other hand, the outer pipe 14 has a plurality of slot-shaped outlet openings 26 that are distributed over the circumference and that differ in their width.

The width of the nozzle slot 12 can thus be varied by rotating the outer pipe 14 (motor or by hand) such that one of the outlet openings 26 is directed onto the printing substrate web 30, in addition, by rotating the inner pipe 16, the length of the nozzle slot 12 can be varied in the direction transverse to the printing substrate web.

FIG. 5 again shows, in cross-section, a nozzle body 10″ according to a further embodiment. In this example, the outer pipe 14 has only a single slot-shaped outlet opening 26 that is directed towards the printing substrate web, and the inner pipe 16 has only a single slot-shaped outlet opening 24 that has approximately the same length and the same width as the outlet opening 26. By twisting the inner pipe 16, the width of the overlapping zone between the outlet openings 24 and 26 and thus the effective width of the nozzle slot 12 can be varied steplessly.

1. Drying nozzle for gassing a running printing substrate web (30) in a rotary printing machine, comprising a hollow nozzle body (10; 10′, 10″), which has a nozzle slot (12) extending transversely to the direction of travel of the printing substrate web (30), characterized in that the nozzle body (10; 10′, 10″) has an inner pipe (16) and an outer pipe (14) enclosing the inner pipe, which in their circumferential wall have at least one outlet opening (24, 26), and in that the nozzle slot (12) is formed by an overlapping zone of the outlet openings (24, 26) of the inner pipe and of the outer pipe and it can be adjusted by changing the angular position of the inner pipe relative to the outer pipe.

2. Drying nozzle according to claim 1, wherein the inner pipe (16) and the outer pipe (14) are cylindrical, and the inner pipe is rotatably supported inside the outer pipe.

3. Drying nozzle according to claim 1 or 2, wherein a first of the two pipes, the inner pipe (16) and the outer pipe (14), has a slot-shaped outlet opening (26), and the second of the two pipes has an outlet opening (24) extending over a larger circumferential angle as a slot-shaped outlet opening (26) and tapers in one direction.

4. Drying nozzle according to claim 3, wherein the slot-shaped outlet opening (26) is formed in the outer pipe (14).

5. Drying nozzle according to one of the preceding claims, in which at least one of the two pipes, the inner pipe (16) and the outer pipe (14), has a plurality of separate outlet openings (26), differing in width, distributed over the circumference.

6. Drying nozzle according to claim 2, wherein the inner pipe (16) and the outer pipe (14) each has a slot-shaped outlet opening (24, 26).

4. The drying nozzle of claim 3, wherein the slot-shaped outlet opening (26) is formed in the outer pipe (14).

5. The drying nozzle of claim 1, in which at least one of the two pipes, the inner pipe (16) and the outer pipe (14), has a plurality of separate outlet openings (26), differing in width, distributed over the circumference.

6. The drying nozzle of claim 2, wherein the inner pipe (16) and the outer pipe (14) each has a slot-shaped outlet opening (24, 26).
